(19) United States
(12) Patent Application Publication
(10) Pub. No.: US 2016/0034975 A1
(43) Pub. Date: Feb. 4, 2016

(54) REFERRING CONTENT USING A FOOD ITEM

(71) Applicant: Steve Cameron, St. Louis, MO (US)

(72) Inventor: Steve Cameron, St. Louis, MO (US)

(21) Appl. No.: 14/809,752

(22) Filed: Jul. 27, 2015

Related U.S. Application Data
(60) Provisional application No. 62/030,158, filed on Jul. 29, 2014.

(51) Int. Cl. G06Q 30/02; A21D 13/00; A23P 1/08; G06Q 50/12; G06K 1/12

(52) U.S. Cl. CPC G06Q 30/0276; G06Q 50/12; G06K 1/121; A23P 1/086; A21D 13/009

(57) ABSTRACT

A food item transforming system comprising a processor coupled to a memory is provided. The processor is configured to associate, in the memory, an identifier with a source of content pertaining to at least one of a drawing, a contest, a game, a coupon, and an advertisement. Additionally, the processor is configured to generate a computer-readable code that encodes at least the identifier, print the computer-readable code to a physical medium, and insert the physical medium into a food item, thereby transforming the food item into an information carrier.

### CROSS-REFERENCE TO RELATED APPLICATIONS

This patent application claims the benefit of U.S. Provisional Patent Application No. 62/030,158, filed Jul. 29, 2014, the entirety of which is incorporated herein by reference.

### BACKGROUND

This description relates to referring content to a client computing device, and more specifically, to using a food item as a medium for referring content to a client computing device.

Known systems for referring content to a client computing device electronically transmit the content or a link to the content to the client computing device. For example, a server computing device may transmit an email to a client computing device, wherein the email includes a link to the content. The content may be, for example, a web page that contains a video or advertisement. When a user of the client computing device clicks on the link, the client computing device receives the content and displays the content to the user. Additionally, known systems encode information, such as stock keeping unit (SKU) information in a code (e.g., a barcode) embodied on a physical medium, such as the packaging for a product. However, known systems do not encode information on a physical medium and include the physical medium in a food item, wherein the encoded information, when read by a client computing device, causes the client computing device to access and display content from a remote computing device.

### BRIEF DESCRIPTION

In one aspect, a food item transforming system comprising a processor coupled to a memory is provided. The processor is configured to associate, in the memory, an identifier with a source of content pertaining to at least one of a drawing, a contest, a game, a coupon, and an advertisement. Additionally, the processor is configured to generate a computer-readable code that encodes at least the identifier, print the computer-readable code to a physical medium, and insert the physical medium into a food item, thereby transforming the food item into an information carrier.

In another aspect, a method for referring content using a food item is provided. The method is implemented by a computing device including a processor coupled to a memory. The method includes associating, in the memory, an identifier with a source of content pertaining to at least one of a drawing, a contest, a game, a coupon, and an advertisement. The method additionally includes generating, by the computing device, a computer-readable code that encodes at least the identifier, printing, by the computing device, the computer-readable code to a physical medium, and inserting, by the computing device, the physical medium into a food item, thereby transforming the food item into an information carrier.

In another aspect, a computer-readable storage device comprising processor-executable instructions is provided. When executed by a food item transforming system having a processor coupled to a memory, the processor-executable instructions cause the food item transforming system to associate, in the memory, an identifier with a source of content pertaining to at least one of a drawing, a contest, a game, a coupon, and an advertisement, generate a computer-readable code that encodes at least the identifier, print the computer-readable code to a physical medium, and insert the physical medium into a food item, thereby transforming the food item into an information carrier.

In another aspect, a food item is provided. The food item includes an edible material and a physical medium at least partially enclosed within the edible material. The physical medium has a computer-readable code embodied thereon and the computer-readable code encodes at least an identifier associated with a source of content pertaining to at least one of a drawing, a contest, a game, a coupon, and an advertisement.

### BRIEF DESCRIPTION OF THE DRAWINGS

FIGS. 1-7 show example embodiments of the methods and systems described herein.

FIG. 1 is a block diagram of a relationship between a food item that includes a physical medium having a computer-readable code embodied thereon and various computing devices.

FIG. 2 is a block diagram of content referenced by the computer-readable code embodied on the physical medium in the food item of FIG. 1.

FIG. 3 is an expanded block diagram of an example embodiment of a server architecture of a content referring system that includes computing devices of FIG. 1 in accordance with one example embodiment of the present disclosure.

FIG. 4 illustrates an example configuration of a client computing device shown in FIGS. 1 and 3.

FIG. 5 illustrates an example configuration of a server computing device shown in FIGS. 1 and 3.

FIG. 6 is a flowchart of an example process that may be performed by the content referring system for referring content to a client computing device through a food item.

FIG. 7 is a diagram of components of one or more example computing devices that may be used in embodiments of the described systems and methods.

### DETAILED DESCRIPTION

Implementations of the methods and systems described herein generate a computer-readable code that may be read by a client computing device to direct the client computing device to content relating to a drawing, a contest, a game, a coupon, and/or an advertisement. The computer-readable code is embodied on a physical medium, for example a slip of paper, and is inserted into a food item, for example a fortune cookie, thereby transforming the food item into an information carrier. The content may be, for example, a software application that is transmitted to and executed locally on the client computing device and/or a website that the client computing device displays, for example using a web browser.

The methods and systems described herein may be implemented using computer programming or engineering techniques including computer software, firmware, hardware or any combination or subset thereof, wherein the technical effect may include at least one of: (a) associating, in a memory, an identifier with a source of content pertaining to at least one of a drawing, a contest, a game, a coupon, and an advertisement; (b) generating a computer-readable code that encodes at least the identifier; (c) printing the computer-readable code to a physical medium; and (d) inserting the physical medium into a food item, thereby transforming the food item into an information carrier. Accordingly, by performing one or more of these steps, a client computing device that scans or otherwise reads the computer-readable code embodied on the physical medium in the food item may be directed to content that is of interest to a user of the client computing device. By printing the computer-readable code to a physical medium and inserting the physical medium into a food item, the systems and methods described herein provide the technical effect of transforming a food item into a different state or thing, namely an information carrier.

In one embodiment, a computer program is provided, and the program is embodied on a computer-readable medium. In an example embodiment, the system is executed on a single computer system, without requiring a connection to a server computer. In a further example embodiment, the system is being run in a Windows® environment (Windows is a registered trademark of Microsoft Corporation, Redmond, Wash.). In yet another embodiment, the system is run on a mainframe environment and a UNIX® server environment (UNIX is a registered trademark of AT&T located in New York, N.Y.). The application is flexible and designed to run in various different environments without compromising any major functionality. In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

The following detailed description illustrates embodiments of the disclosure by way of example and not by way of limitation. It is contemplated that the disclosure has general application to directing a client computing device to content in industrial, commercial, and/or residential applications.

As used herein, an element or step recited in the singular and preceded with the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

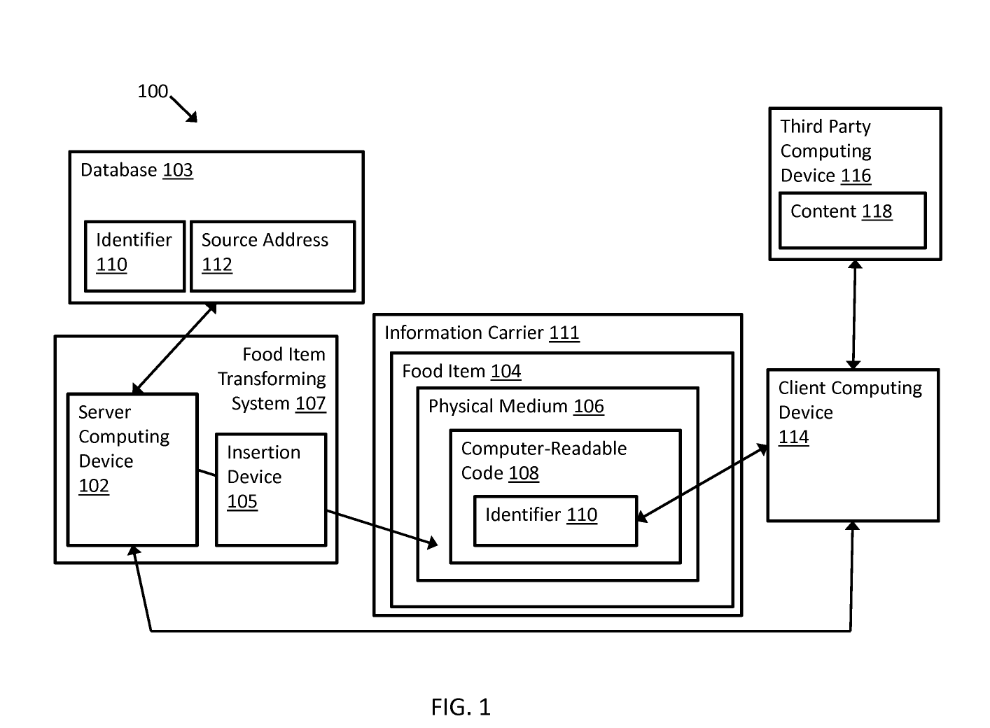

FIG. 1 is a block diagram of a relationship 100 between a food item 104 that includes a physical medium 106 having a computer-readable code 108 embodied thereon and various computing devices. A food item transforming system 107 includes a server computing device 102 and an insertion device 105, described in more detail herein. Server computing device 102 (“encoder computing device”) associates, in a memory, for example a database 103 in communication with server computing device 102, an identifier 110 with a source address 112. Identifier 110 is, for example, one or more numbers, characters, or symbols. Source address 112 is an address (e.g., uniform resource locator (URL)) of a computing device, for example server computing device 102 or a third party computing device 116 that is configured to transmit content 118 to a requesting computing device, for example a client computing device 114. Server computing device 102 generates a computer-readable code 108 that encodes identifier 110. Computer-readable code 108 is, for example, a barcode, a quick response code (QR code), a magnetic code, or other code that may be scanned or read by a computing device, such as client computing device 114, using an optical sensor (e.g., a camera), a barcode scanner, magnetic sensor, and/or a radio frequency sensor. In some implementations, computer-readable code 108 utilizes multiple spatial dimensions, shapes, and/or colors to encode identifier 110. Server computing device 102 prints computer-readable code 108 to a physical medium 106, or otherwise causes physical medium 106 to include computer-readable code 108. Physical medium 106 is any surface, device, or item adapted to store or bear the computer-readable code 108. For example, physical medium 106 is, in some implementations, a slip of paper. In other implementations, physical medium 106 is made of any other suitable material such as plastic or metal. In some implementations, physical medium 106 is a radio-frequency identification (RFID) tag.

Server computing device 102 inserts or otherwise includes physical medium 106 into food item 104. Food item 104 includes any edible material, for example a fortune cookie. In some implementations, server computing device 102 transmits an instruction to an insertion device 105 to insert or otherwise include physical medium 106 into food item 104. In other implementations, server computing device 102 inserts or otherwise includes physical medium 106 into food item 104 directly. In some implementations, insertion device 105 is included within server computing device 102. By inserting physical medium 106 into food item 104, food item transforming system 107 transforms food item 104 into a different state or thing, namely an information carrier 111.

A user of client computing device 114 receives food item 104 and discovers physical medium 106 within food item 104. The user then uses client computing device 114 to scan or read computer-readable code 108 from physical medium 106 to obtain identifier 110. Client computing device 114 is configured to transmit a request to server computing device 102, wherein the request includes identifier 110. Server computing device 102 then accesses source address 112 from database 103, using identifier 110, and transmits a response to client computing device 114 that includes source address 112. As described above, source address 112 may be, for example, an address such as a URL of a computing device that stores, and is configured to transmit, content 118. For example, source address 112 may be a URL of third party computing device 116. In response to receiving the response from server computing device 102 including source address 112, client computing device 114 transmits a request based on source address 112. More specifically, client computing device 114 transmits a request to third party computing device 116. In response, third party computing device 116 transmits content 118 to client computing device 114.

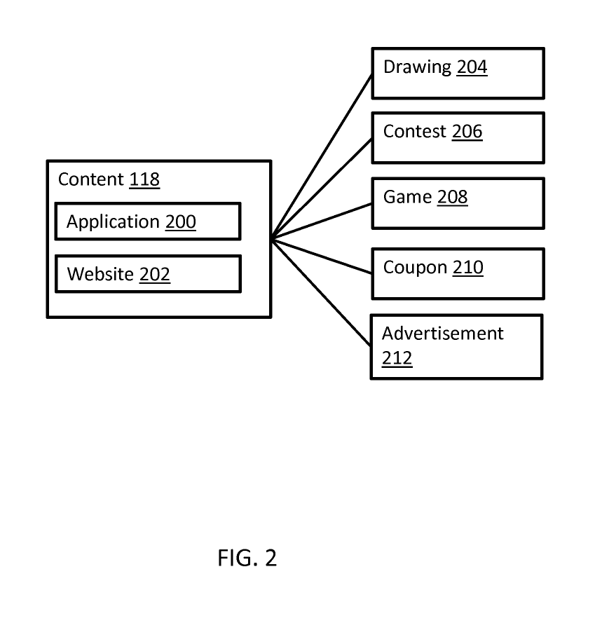

FIG. 2 is a block diagram of content 118. As described above, content 118 is transmitted to client computing device 114 by a computing device (e.g., third party computing device 116) that is configured to respond to a request based on source address 112. Content 118 may include a software application 200 to be received and executed by client computing device 114, or a website 202 that causes client computing device 114 to present (e.g., display) information about a drawing 204 or a contest 206. For example, the content 118 enables a user of client computing device 114 to learn about and register for drawing 204 or contest 206. In other implementations, content 118 causes client computing device 114 to execute a game 208 that the user may play. In other implementations, content 118 causes client computing device 114 to present a coupon 210 or an advertisement 212 for products and/or services that the user may be interested in purchasing.

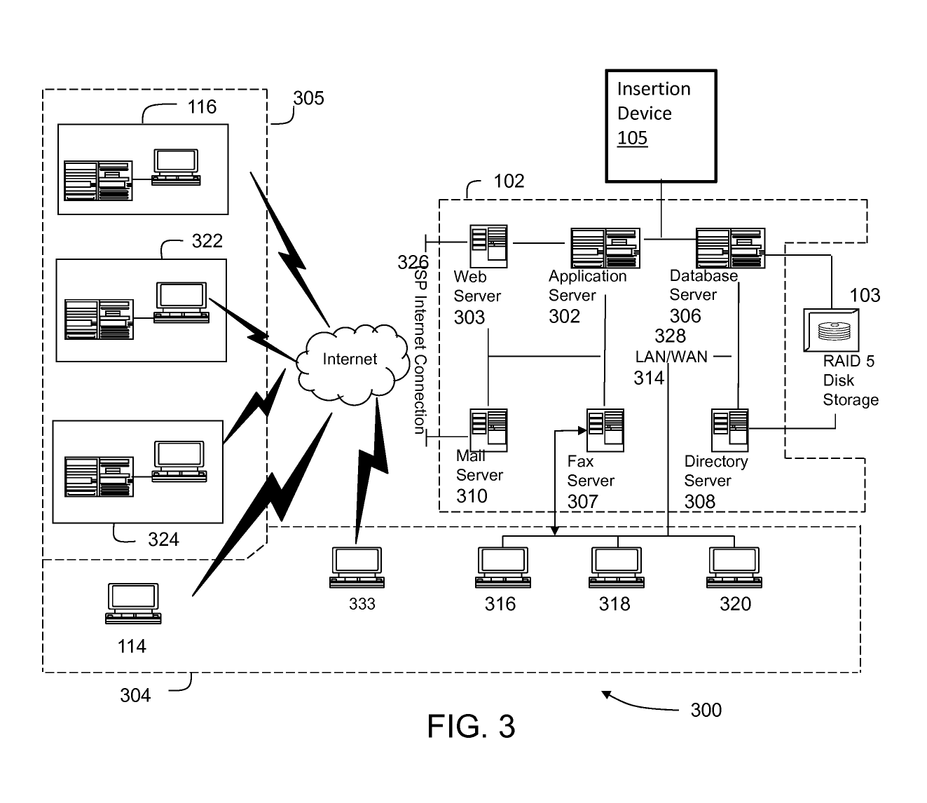

FIG. 3 is an expanded block diagram of an example embodiment of a server architecture of a content referring system 300 in accordance with one embodiment of the present disclosure. Content referring system 300 includes server system (server computing device) 102, insertion device 105, client systems 304, and content source systems 305. Server system 102 includes a database server 306, an application server 302, a web server 303, a fax server 307, a directory server 308, and a mail server 310. Database 103 (e.g., a disk storage unit), is coupled to database server 306 and directory server 308. Servers 302, 303, 306, 307, 308, and 310 are coupled in a local area network (LAN) 314. In addition, a system administrator's workstation 316, a user workstation 318, and a supervisor's workstation 320 are coupled to LAN 314. Alternatively, workstations 316, 318, and 320 are coupled to LAN 314 using an Internet link or are connected through an Intranet.

Each workstation, 316, 318, and 320, is a personal computer having a web browser. Although the functions performed at the workstations typically are illustrated as being performed at respective workstations 316, 318, and 320, such functions can be performed at one of many personal computers coupled to LAN 314. Workstations 316, 318, and 320 are illustrated as being associated with separate functions only to facilitate an understanding of the different types of functions that can be performed by individuals having access to LAN 314.

Server system 102 is configured to be communicatively coupled to various entities, including third party computing devices 116, 322, and 324 (i.e., sources of content), client computing devices 114 and 333, and other computing devices using an Internet connection 326. The communication in the example embodiment is illustrated as being performed using the Internet, however, any other wide area network (WAN) type communication can be utilized in other embodiments, i.e., the systems and processes are not limited to being practiced using the Internet. In addition, and rather than WAN 328, local area network 314 could be used in place of WAN 328.

In the example embodiment, any authorized individual or entity having a computing device may access system 102. At least one of the client systems includes a manager workstation 316 located at a remote location. In some implementations, some or all of workstations 316, 318, and 320 and client computing devices 114 and 333 are configured to operate a web browser and to communicate with server system 102. In some implementations, fax server 307 is configured to communicate with one or more client systems, such as workstations 316, 318, and 320.

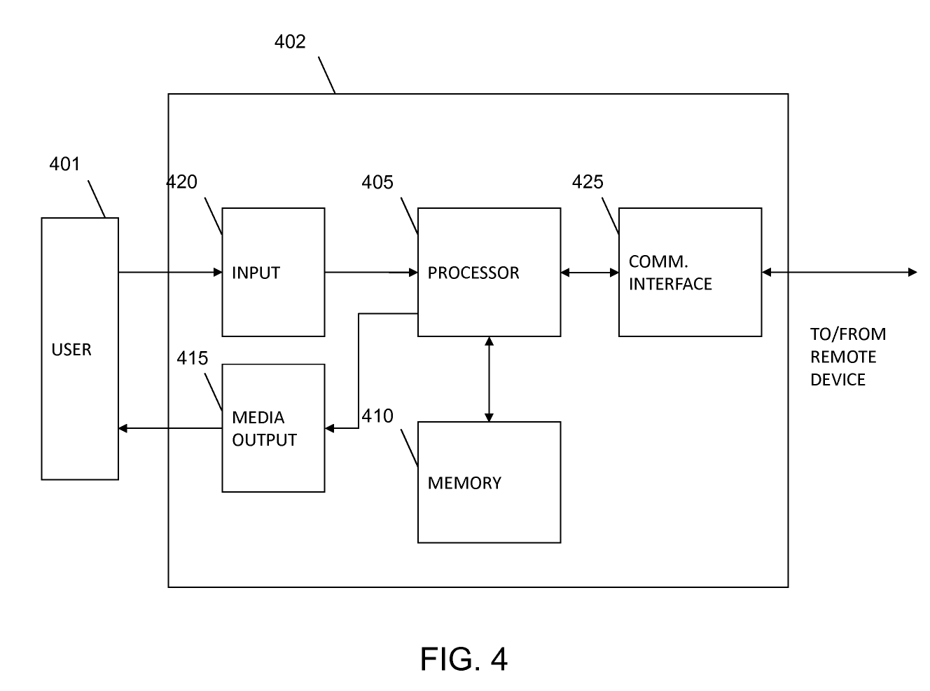

FIG. 4 illustrates an example configuration of a client computing device 402 operated by a user 401. Client computing device 402 is representative of client systems 304 (shown in FIG. 3). Client computing device 402 includes one or more processors 405 for executing instructions. In some embodiments, executable instructions are stored in a memory area 410. Processor 405 may include one or more processing units (e.g., in a multi-core configuration). One or more memory devices 410 are any one or more devices allowing information such as executable instructions and/or other data to be stored and retrieved. One or more memory devices 410 may include one or more computer-readable media.

Client computing device 402 also includes at least one media output component 415 for presenting information to user 401. Media output component 415 is any component capable of conveying information to user 401. In some embodiments, media output component 415 includes an output adapter such as a video adapter and/or an audio adapter. An output adapter is operatively coupled to processor 405 and operatively couplable to an output device such as a display device (e.g., a liquid crystal display (LCD), organic light emitting diode (OLED) display, cathode ray tube (CRT), or “electronic ink” display) or an audio output device (e.g., a speaker or headphones).

In some embodiments, client computing device 402 includes an input device 420 for receiving input from user 401. Input device 420 may include, for example, a keyboard, a pointing device, a mouse, a stylus, a touch sensitive panel (e.g., a touch pad or a touch screen), a gyroscope, an accelerometer, a position detector, an audio input device, a camera or other optical sensor, a barcode scanner, a magnetic sensor, and/or an radio frequency sensor. A single component such as a touch screen may function as both an output device of media output component 415 and input device 420.

Client computing device 402 may also include a communication interface 425, which is communicatively couplable to remote devices such as server system 102 and one or more content source systems 305. Communication interface 425 may include, for example, a wired or wireless network adapter or a wireless data transceiver for use with a mobile phone network (e.g., Global System for Mobile communications (GSM), 3G, 4G or Bluetooth) or other mobile data network (e.g., Worldwide Interoperability for Microwave Access (WIMAX)).

Stored in one or more memory devices 410 are, for example, computer-readable instructions for providing a user interface to user 401 via media output component 415 and, optionally, receiving and processing input from input device 420. A user interface may include, among other possibilities, a web browser and client application. Web browsers enable users, such as user 401, to display and interact with media and other information typically embedded on a web page or a website from server system 102 or a content source system 305. A client application allows user 401 to interact with a server application from server system 102 or a content source system 305.

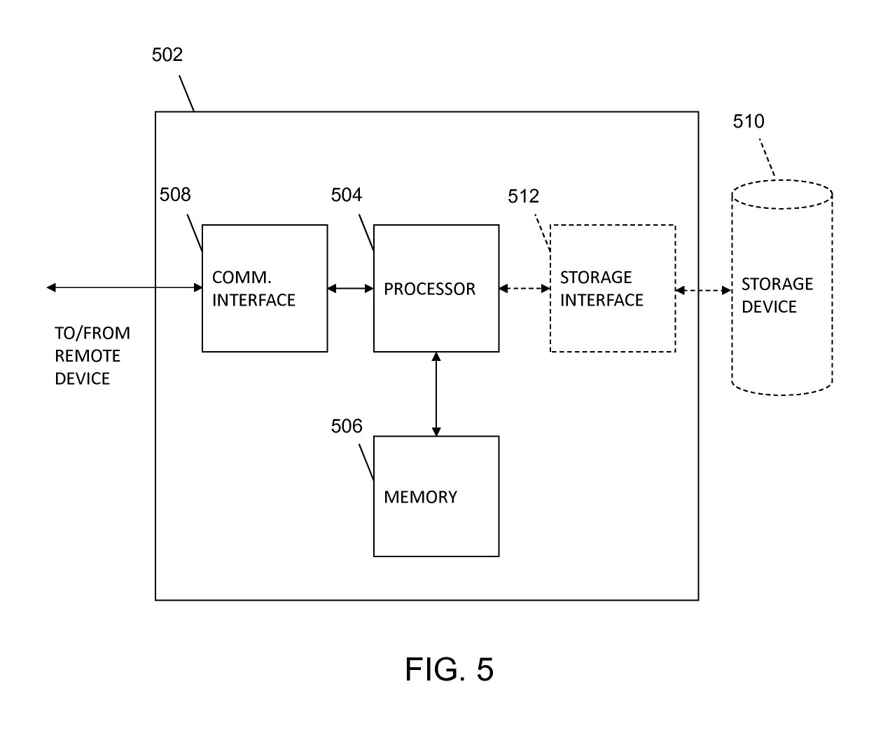

FIG. 5 illustrates an example configuration of a server computing device 502 such as server system 102 (shown in FIGS. 1 and 3) and content source systems 305. Server computing device 502 may include, but is not limited to, database server 306, application server 302, web server 303, fax server 307, directory server 308, mail server 310 and insertion device 105.

Server computing device 502 includes one or more processors 504 for executing instructions. Instructions may be stored in one or more memory devices 506. One or more processors 504 may include one or more processing units (e.g., in a multi-core configuration).

One or more processors 504 are operatively coupled to a communication interface 508 such that server computing device 502 is capable of communicating with a remote device such as client computing device 402 or another server computing device 502. For example, communication interface 508 may receive requests from client systems 304 via the Internet, as illustrated in FIGS. 1 and 3.

One or more processors 504 may also be operatively coupled to one or more storage devices 510. One or more storage devices 510 are any computer-operated hardware suitable for storing and/or retrieving data. In some embodiments, one or more storage devices 510 are integrated in server computing device 502. For example, server computing device 502 may include one or more hard disk drives as one or more storage devices 510. In other embodiments, one or more storage devices 510 are external to server computing device 502 and may be accessed by a plurality of server computing devices 502. For example, one or more storage devices 510 may include multiple storage units such as hard disks or solid state disks in a redundant array of inexpensive disks (RAID) configuration. One or more storage devices 510 may include a storage area network (SAN) and/or a network attached storage (NAS) system. In some embodiments, one or more storage devices 510 may include database 103.

In some embodiments, one or more processors 504 are operatively coupled to one or more storage devices 510 via a storage interface 512. Storage interface 512 is any component capable of providing one or more processors 504 with access to one or more storage devices 510. Storage interface 512 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing one or more processors 504 with access to one or more storage devices 510.

One or more memory devices 410 and 506 may include, but are not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are example only, and are thus not limiting as to the types of memory usable for storage of a computer program.

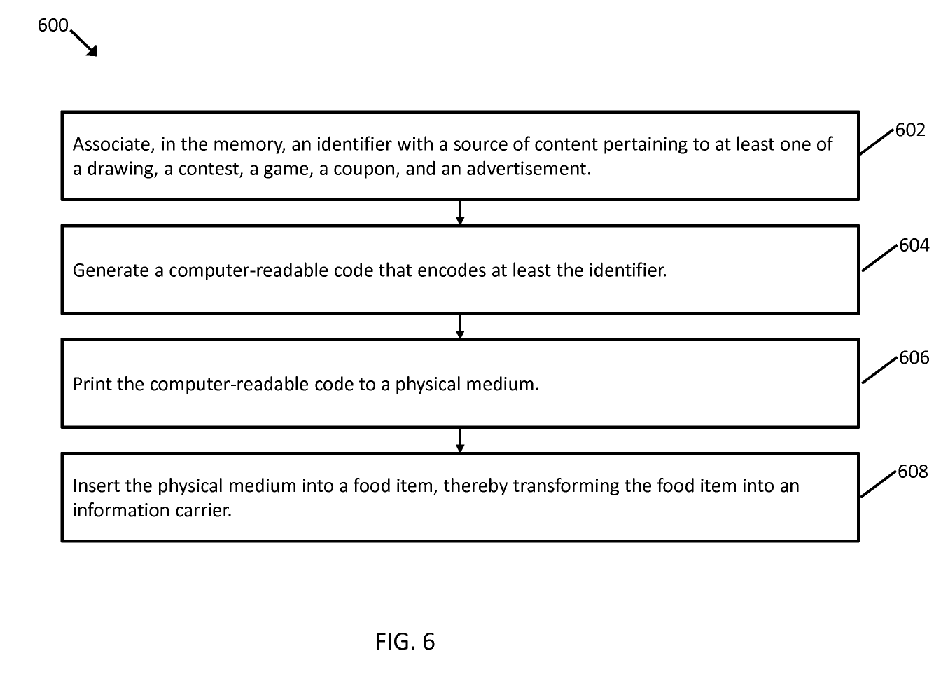

FIG. 6 is a flowchart of an example process 600 that may be performed by content referring system 300 for referring content (e.g., content 118) to a client computing device (e.g., client computing device 114) through a food item (e.g., food item 104). Initially, content referring system 300, and more specifically, food item transforming system 107 associates 602, in memory (e.g., database 103), an identifier (e.g., identifier 110) with a source of content (e.g., source address 112 of third party computing device 116). The content (e.g., content 118) pertains to at least one of a drawing 204, a contest 206, a game 208, a coupon 210, and an advertisement 212. Additionally, food item transforming system 107 generates 604 a computer-readable code (e.g., computer-readable code 108) that encodes the identifier (e.g., identifier 110). Additionally, food item transforming system 107 prints 606 the computer-readable code (e.g., computer-readable code 108) to a physical medium (e.g., physical medium 106), for example a slip of paper. Additionally, food item transforming system 107 inserts 608 the physical medium (e.g., physical medium 106) into a food item (e.g., food item 104), for example a fortune cookie, thereby transforming food item 104 into an information carrier 111.

In some implementations, food item transforming system 107 is configured to receive a request from a client computing device (e.g., client computing device 114), wherein the request includes the identifier 110 and food item transforming system 107 transmits an instruction to client computing device 114 to access a website associated with the source of content, in response to receiving the request. For example, in some implementations, food item transforming system 107 transmits source address 112 to client computing device 114, wherein source address 112 is a URL for content 118 hosted on third party computing device 116. In some implementations, for example in implementations in which content 118 is stored in database 103, food item transforming system 107 transmits content 118, or at least a portion of content 118, to client computing device 114 in response to receiving the request. In some implementations, food item transforming system 107 is configured to print the computer-readable code 108 in a format that is readable by at least one of an optical sensor, a barcode scanner, and a magnetic sensor of a client computing device (e.g., client computing device 114). In some implementations, food item transforming system 107 is configured to print the computer-readable code 108 using at least one of multiple colors, multiple shapes, and multiple spatial dimensions. For example, in some implementations, food item transforming system 107 prints computer-readable code 108 in a two-dimensional format, such as a QR (quick response) code, or a three dimensional format, that may contain, for example, extrusions or indentations in the physical medium 106. In some implementations, food item transforming system 107 encodes an instruction to access the source of content (e.g., third party computing device 116) directly into the computer-readable code 108, rather than encoding an identifier 110 that food item transforming system 107 then cross-references with source address 112. In such implementations, client computing device 114 does not transmit a request that includes identifier 110 to food item transforming system 107 prior to requesting the content 118 from the source of content (e.g., third party computing device 116). Rather, in such implementations, upon reading computer-readable code 108, client computing device 114 transmits a request for content 118 directly to third party computing device 116. More specifically, in such implementations, computer-readable code 108 and/or identifier 110 includes the source address 112 (e.g., URL) of content 118.

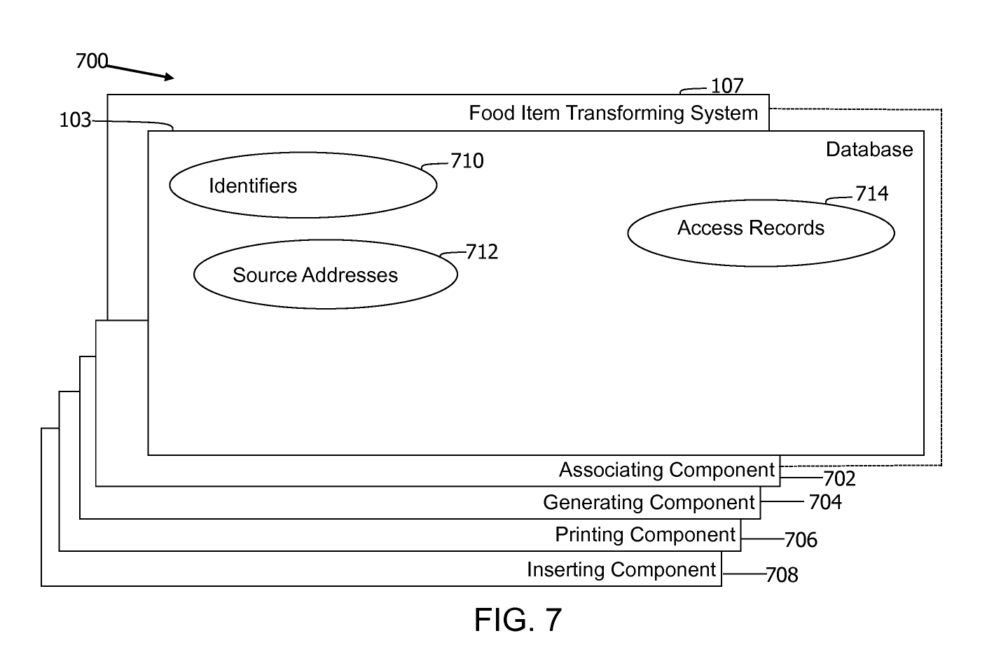

FIG. 7 is a diagram 700 of components of one or more example computing devices, for example food item transforming system 107, that may be used in embodiments of the described systems and methods. FIG. 7 further shows a configuration of database 103. Database 103 is communicatively coupled to food item transforming system 107.

Food item transforming system 107 includes an associating component 702 for associating, in memory (e.g., database 103), an identifier (e.g., identifier 110) with a source of content (source address 112 of third party computing device 116 which hosts content 118) pertaining to at least one of a drawing 204, a contest 206, a game 208, a coupon 210, and an advertisement 212. Food item transforming system 107 additionally includes a generating component 704 for generating a computer-readable code 108 that encodes at least the identifier 110. Additionally, food item transforming system 107 includes a printing component 706 for printing the computer-readable code 108 to a physical medium 106. Additionally, food item transforming system 107 includes an inserting component 708 (e.g., insertion device 105) for inserting the physical medium 106 into a food item 104.

In an example embodiment, database 103 is divided into a plurality of sections, including but not limited to, an identifiers section 710, a source addresses section 712, and an access records section 714. In some implementations, the access records section 714 stores a record of when a client computing device (e.g., client computing device 114) transmitted a request to food item transforming system 107 that includes an identifier (e.g., identifier 110) stored in database 103. These sections within database 103 are interconnected to retrieve and store information in accordance with the functions and processes described above.

The term processor, as used herein, refers to central processing units, microprocessors, microcontrollers, reduced instruction set circuits (RISC), application specific integrated circuits (ASIC), logic circuits, and any other circuit or processor capable of executing the functions described herein.

As used herein, the terms “software” and “firmware” are interchangeable, and include any computer program stored in memory for execution by processor 405, 504, including RAM memory, ROM memory, EPROM memory, EEPROM memory, and non-volatile RAM (NVRAM) memory. The above memory types are example only, and are thus not limiting as to the types of memory usable for storage of a computer program.

As will be appreciated based on the foregoing specification, the above-discussed embodiments of the disclosure may be implemented using computer programming or engineering techniques including computer software, firmware, hardware or any combination or subset thereof. Any such resulting computer program, having computer-readable and/or computer-executable instructions, may be embodied or provided within one or more computer-readable media, thereby making a computer program product, i.e., an article of manufacture, according to the discussed embodiments of the disclosure. These computer programs (also known as programs, software, software applications or code) include machine instructions for a programmable processor, and can be implemented in a high-level procedural and/or object-oriented programming language, and/or in assembly/machine language. As used herein, the terms “machine-readable medium,” “computer-readable medium,” and “computer-readable media” refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium,” “computer-readable medium,” and “computer-readable media,” however, do not include transitory signals (i.e., they are “non-transitory”). The term “machine-readable signal” refers to any signal used to provide machine instructions and/or data to a programmable processor.

The embodiments of the method and system described above generate a computer-readable code embodied on a physical medium that is included within a food item, thereby transforming the food item into an information carrier. The computer-readable code directs a client computing device to content relating to a drawing, a contest, a game, a coupon, and an advertisement. Accordingly, a user of a client computing device may read the computer-readable code using the client computing device and view the content.

This written description uses examples, including the best mode, to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A food item transforming system comprising a processor coupled to a memory, said processor configured to:
associate, in the memory, an identifier with a source of content pertaining to at least one of a drawing, a contest, a game, a coupon, and an advertisement;
generate a computer-readable code that encodes at least the identifier;
print the computer-readable code to a physical medium; and
insert the physical medium into a food item, thereby transforming the food item into an information carrier.

2. The food item transforming system of claim 1, further configured to insert the physical medium into a fortune cookie.

3. The food item transforming system of claim 1, further configured to receive a request from a client computing device, wherein the request includes the identifier.

4. The food item transforming system of claim 3, further configured to transmit an instruction to the client computing device to access a website associated with the source of content in response to receiving the request.

5. The food item transforming system of claim 3, further configured to transmit at least a portion of the content to the client computing device in response to receiving the request.

6. The food item transforming system of claim 1, further configured to print the computer-readable code in a format that is readable by at least one of an optical sensor, a barcode scanner, and a magnetic sensor of a client computing device.

7. The food item transforming system of claim 1, further configured to print the computer-readable code using at least one of multiple colors, multiple shapes, and multiple spatial dimensions.

8. A method for referring content using a food item, said method is implemented by a food item transforming system including a processor coupled to a memory, said method comprising:
associating, in the memory, an identifier with a source of content pertaining to at least one of a drawing, a contest, a game, a coupon, and an advertisement;
generating, by the computing device, a computer-readable code that encodes at least the identifier;
printing, by the computing device, the computer-readable code to a physical medium; and
inserting, by the computing device, the physical medium into a food item, thereby transforming the food item into an information carrier.

9. The method of claim 8, wherein inserting the physical medium into a food item further comprises inserting the physical medium into a fortune cookie.

10. The method of claim 8, further comprising receiving, by the food item transforming system, a request from a client computing device, wherein the request includes the identifier.

11. The method of claim 10, further comprising transmitting an instruction to the client computing device to access a website associated with the source of content in response to receiving the request.

12. The method of claim 10, further comprising transmitting at least a portion of the content to the client computing device in response to receiving the request.

13. The method of claim 8, further comprising printing, by the food item transforming system, the computer-readable code in a format that is readable by at least one of an optical sensor, a barcode scanner, and a magnetic sensor of a client computing device.

14. The method of claim 8, further comprising printing, by the food item transforming system, the computer-readable code using at least one of multiple colors, multiple shapes, and multiple spatial dimensions.

15. A computer-readable storage device comprising processor-executable executable instructions that, when executed by a food item transforming system having a processor coupled to a memory, cause the food item transforming system to:
associate, in the memory, an identifier with a source of content pertaining to at least one of a drawing, a contest, a game, a coupon, and an advertisement;
generate a computer-readable code that encodes at least the identifier;
print the computer-readable code to a physical medium; and
insert the physical medium into a food item, thereby transforming the food item into an information carrier.

16. The computer-readable storage device of claim 15, wherein said processor-executable instructions further cause the food item transforming system to insert the physical medium into a fortune cookie.

17. The computer-readable storage device of claim 15, wherein said processor-executable instructions further cause the food item transforming system to receive a request from a client computing device, wherein the request includes the identifier.

18. The computer-readable storage device of claim 17, wherein said processor-executable instructions further cause the food item transforming system to transmit an instruction to the client computing device to access a website associated with the source of content in response to receiving the request.

19. The computer-readable storage device of claim 17, wherein said processor-executable instructions further cause the food item transforming system to transmit at least a portion of the content to the client computing device in response to receiving the request.

20. The computer-readable storage device of claim 15, wherein said processor-executable instructions further cause the food item transforming system to print the computer-readable code in a format that is readable by at least one of an optical sensor, a barcode scanner, and a magnetic sensor of a client computing device.

21. A food item comprising:
edible material; and
a physical medium at least partially enclosed within the edible material, wherein said physical medium has a computer-readable code embodied thereon and the computer-readable code encodes at least an identifier associated with a source of content pertaining to at least one of a drawing, a contest, a game, a coupon, and an advertisement.
